(19) United States
(12) Patent Application Publication
(10) Pub. No.: US 2015/0074219 A1
(43) Pub. Date: Mar. 12, 2015

(54) HIGH AVAILABILITY NETWORKING USING TRANSACTIONAL MEMORY

(71) Applicant: Brocade Communications Systems, Inc., San Jose, CA (US)

(72) Inventors: Bill Ying Chin, San Jose, CA (US); Poongovan Ponnavaikko, Santa Clara, CA (US); Babu Neelam, Santa Clara, CA (US)

(73) Assignee: Brocade Communications Systems, Inc., San Jose, CA (US)

(21) Appl. No.: 14/266,517

(22) Filed: Apr. 30, 2014

Related U.S. Application Data
(60) Provisional application No. 61/845,934, filed on Jul. 12, 2013.
(60) Provisional application No. 61/864,371, filed on Aug. 9, 2013.

(51) Int. Cl. G06F 15/167; H04L 29/08

(52) U.S. Cl. CPC G06F 15/167; H04L 67/2842
USPC 709/213

(57) ABSTRACT

Techniques for facilitating high availability in a device (e.g., a network device) comprising redundant processing entities (e.g., one or more processors, one or more cores, etc.) and a transactional memory system. The transactional memory system comprises a memory that is shareable between the redundant processing entities and ensures consistency of information stored in the memory at the atomicity of a transaction. A first processing entity may operate in a first mode (e.g., active mode) while a second processing entity operates in a second mode (e.g., standby mode). Operational state information used by the active processing entity for performing a set of functions in the first mode may be stored in the shared memory. Upon a switchover, the second processing entity may start to operate in the first mode and commence performing the set of functions using the operational state information stored by the transactional memory system.

### CROSS-REFERENCES TO RELATED APPLICATIONS

The present application is a non-provisional of and claims the benefit and priority under 35 U.S.C. 119(e) of (1) U.S. Provisional Application No. 61/845,934, filed Jul. 12, 2013, entitled TRANSACTIONAL MEMORY LAYER, and (2) U.S. Provisional Application No. 61/864,371, filed Aug. 9, 2013, entitled TRANSACTIONAL MEMORY LAYER. The entire contents of the 61/845,934 and 61/864,371 applications are incorporated herein by reference for all purposes.

### BACKGROUND

The disclosed embodiments relate generally to networking and more particularly to techniques for providing reliable networking functionality and high availability.

In order to reduce down-time and provide high availability, several network devices provide redundant components such as redundant processors that are configured to facilitate data routing functions performed by the network device. In a network device with redundant processors, at any point in time, one of the processors may be configured to operate in active mode while the other processor may operate in standby mode where the active processor is configured to perform certain functions that are not performed by the standby processor. The processor operating in the active mode is sometimes referred to as the active processor and the processor operating in standby mode is referred to as the standby processor. Processors operating according to the active/standby mode model provide redundancy such that, when the active processor fails, the standby processor becomes the active processor and starts performing the functions performed in active mode. Various events may cause a switchover (also sometimes referred to as a failover) in the network device, wherein the standby processor starts operating in the active mode and takes over routing functionality, from the previous active processor. The previously active processor may become the standby processor, as a result of the switchover.

When a switchover occurs, the new active processor rebuilds its processing and routing state information. This rebuilding or restoring of the processing and/or routing state can take several seconds or even minutes, until the new active processor has rebuilt the processing and routing state information, during which routing of traffic may be interrupted.

### BRIEF SUMMARY

Certain embodiments of the present invention provide techniques for providing reliable networking functionality and high availability using transactional memory.

Supporting high availability may be desirable for networking equipment vendors. High availability refers to a system design that ensures a high level of reliance and low down-time associated with the system. In some embodiments, high availability is facilitated by providing redundant processing entities (e.g., two or more processors, two or more cores, etc.) with active components and standby components. Providing redundancy may reduce instances where the networking device encounters unrecoverable errors and has to be fully rebooted or becomes completely non-functional and needs to be manually replaced. Such instances result in long network outages that are not acceptable for many mission-critical applications and are expensive to maintain. However, even with redundancy, switching over from the active components to the standby components may require time for rebuilding and reinitializing the processing and routing state of the new active components.

Embodiments of the invention generally describe techniques for reducing the down-time during switching over from the active processing entity to the standby processing entity by sharing memory between the active processing entity and standby processing entity and maintaining consistency of the shared memory for a transaction comprising a plurality of operations.

In certain embodiments, a network device may include a memory, a first processing entity, a second processing entity and a transactional memory system comprising a memory shareable between the first processing entity and the second processing entity. The first processing entity may operate in a first mode, such as an active mode. The first processing entity may perform a first set of tasks in the first mode. An example of a first set of tasks may include, but is not limited to, routing of packets from one device to another device at the network device. In certain embodiments, the second processing entity may operate in a second mode when the first processing entity is operating in the first mode. The second processing entity may not perform the first set of tasks in the second mode.

The first processing entity may commence execution of a transaction while operating in the first mode. The transaction may be a plurality of operations. A portion of the memory may be in a first state prior to commencing execution of the transaction by the first processing entity. In one scenario, the first processing entity may stop executing the transaction on the first processing entity in the first mode after execution of a subset of the plurality of operations from the transaction. In one embodiment, at least one from the plurality of operations may not be included in the subset of the plurality of operations. The subset of operations may be operable to change the state of the portion of the memory from the first state to a different state when committed to the portion of the memory. In some embodiments, the first processing entity may stop executing the transaction in the first mode in response to detecting a failure condition during the executing of the transaction. In other embodiments, the first processing entity may stop executing the transaction in the first mode in response to a signal. A signal may be generated due to a request to upgrade the software executing on the first processing entity.

In some embodiments, after the first processing entity stops executing the transaction in the first mode, the network device may cause the second processing entity to operate in the first mode instead of the first processing entity. In some implementations, the first processing entity operates in the second mode after stopping execution of the transaction on the first processing entity in the first mode. Furthermore, the second processing entity may commence the execution of the transaction. In one implementation, the transactional memory system may cause the state of the portion of memory to be in the first state prior to commencement of the execution of the transaction by the second processing entity.

In one example implementation, components of the network device perform processing to cause the state of the portion of memory to be in the first state by tracking changes to the portion of the memory by the first processing entity during the executing of the transaction on the first processing entity and reverting the changes back to the first state prior to commencement of the execution of the transaction by the second processing entity. In another example implementation, components of the network device perform processing to cause the state of the portion of memory to be in the first state by buffering changes directed to the portion of the memory during executing of the transaction in a memory buffer, and discarding the buffered changes in the memory buffer.

In certain embodiments, the portion of memory may be implemented using persistent memory that does not change from the time when the first processing entity stops executing the transaction in the first mode and the second processing entity starts operating the first mode. In certain embodiments, persistent memory may be implemented by maintaining power to the portion of memory. In other embodiments, persistent memory may be implemented by using non-volatile memory that does not change when it is not powered.

The foregoing has outlined rather broadly features and technical advantages of examples in order that the detailed description that follows can be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages, will be better understood from the following description when considered in connection with the accompanying figures. Each of the figures is provided for the purpose of illustration and description only and not as a definition of the limits of the claims.

### BRIEF DESCRIPTION OF THE DRAWINGS

FIG. 1 illustrates a simplified block diagram of a computing device according to one or more embodiments of the invention.

FIG. 2 illustrates a simplified computer program according to one or more embodiments.

FIG. 3 illustrates a simplified block diagram of the computing device, prior to execution of the transaction, according to one or more embodiments of the invention.

FIG. 4 illustrates a simplified block diagram of the computing device, during the execution of the transaction, according to one or more embodiments of the invention.

FIG. 5 illustrates a simplified block diagram of the computing device, subsequent to the transaction being completed and committed, according to one or more embodiments of the invention.

FIG. 6 illustrates a simplified block diagram of the computing device that illustrates interrupting a transaction while executing the transaction, according to one or more embodiments of the invention.

FIG. 7 illustrates a simplified block diagram of the computing device depicting the switchover of the second processing entity from the standby mode to the active mode.

FIG. 8 illustrates a simplified block diagram for writing to memory allocated as transactional memory according to one embodiment of the invention.

FIG. 9 illustrates another simplified block diagram for writing to memory allocated as transactional memory according to another embodiment of the invention.

FIG. 10 depicts a simplified flowchart illustrating the method performed according to one or more embodiments of the invention.

FIG. 11 illustrates another simplified block diagram of a computing device according to one or more embodiments of the invention.

FIG. 12 depicts a simplified flowchart illustrating the method performed according to one or more embodiments of the invention.

FIG. 13 depicts a simplified block diagram of a network device that may be configured to perform embodiments of the present invention.

### DETAILED DESCRIPTION

In the following description, for the purposes of explanation, specific details are set forth in order to provide a thorough understanding of embodiments of the invention. However, it will be apparent that various embodiments may be practiced without these specific details. The figures and description are not intended to be restrictive.

The availability of a system is generally measured as the proportion of time that the system is available to perform its intended function. High availability refers to the system's ability to ensure low down-time and high up-time. In many systems, including in network devices, high availability is facilitated by providing redundancies, for example, by providing redundant processing entities. A processing entity may be a physical processor, a group of physical processors, a core, a group of cores, and the like or a virtual machine operating on any such processing logic. One processing entity is configured to operate in the active mode while the other redundant processing entity operates in the standby mode. The processing entity operating in active mode is referred to as the active processing entity and the processing entity operating in standby mode is referred to as the standby processing entity. For example, a network device may provide redundant processors with one of the processors operating in active mode (referred to as the active processor) while the other processor operates in standby mode (referred to as the standby processor).

Typically, the active processing entity is configured to perform a certain set of functions that are not performed by the standby processing entity. For example, in a network device, the active processing entity may be configured to perform functions performed by the network device such as one or more functions related to forwarding and routing of network data. These functions may not be performed by the standby processing entity. In response to certain events, the standby processing entity is configured to start operating in the active mode and become the new active processing entity and take over performance of the functions performed in active mode, hopefully without any interruption to the functions being performed. The event that causes the previous standby processing entity to become the new active processing entity may also cause the previous active processing entity to operate in the standby mode and become the new standby processing entity.

The process of a previous standby processing entity becoming the new active processing entity and the previous active processing entity becoming the new standby processing entity is sometimes referred to as a switchover or a failover. Network devices strive to perform a switchover with minimal, and preferably no, impact or interruption of the functions being performed by the network device. A switchover thus reduces the downtime of a network device and increases its availability.

A switchover may be caused by various different events, including anticipated or voluntary events and/or unanticipated or involuntary events. A voluntary or anticipated event is typically a voluntary user-initiated event that is intended to cause the active processing entity to voluntarily yield control to the standby processing entity. An instance of such an event is a command received by the network device from a network administrator to perform a switchover. There are various situations when a network administrator may cause a switchover to occur on purpose, such as when software for the active processing entity needs to be upgraded to a newer version. As another example, a switchover may be voluntarily initiated by the system administrator upon noticing performance degradation on the active processing entity or upon noticing that software executed by the active processing entity is malfunctioning. In such scenarios, the network administrator may voluntarily issue a command to the network device that causes a switchover, with the hope that problems associated with the current active processing entity will be remedied when the standby processing entity becomes the new active processing entity. A command to cause a voluntary switchover may also be initiated as part of scheduled maintenance. Various interfaces, including, but not limited to, a command line interface (CLI), may be provided for initiating a voluntary switchover.

An involuntary or unanticipated switchover (also sometimes referred to as a failover) may occur due to some critical failure (e.g., a problem with the software executed by the active processing entity, failure in the operating system loaded by the active processing entity, hardware-related errors on the active processing entity or other router component, and the like) in the active processing entity.

While operating in active mode, the active processing entity may use information (referred to as “operational state information”) that the active processing entity uses to perform the set of functions performed in active mode. For example, an active processing entity in a network device performing forwarding functions may use information such as routing tables, spanning tree tables, networking metrics, and the like. As part of performing the active mode functions, the active processing entity may build and/or make changes to the operational state information to, for example, reflect changes in the network topology. When a switchover occurs, the operational state information is also needed by the new active processing entity in order to perform the set of functions performed in active mode. The operational state information available to the new active processing entity thus needs to be synchronized with the latest state of the operational state information accessible to the previous active processing entity. The information used by the previous active processing entity needs to be synchronized to the information used by the new active processing entity.

In certain embodiments, the new active processing entity has to first build the operational state information before it can start performing the active mode set of functions. This, however, can take some time during which the active mode set of functions is not performed by the new active processing entity and translates to down-time of the device, thereby reducing availability. It is thus desirable that the new active processing entity be able to access the operational state information as soon as possible upon a switchover to reduce or even prevent any down time for the network device.

In certain embodiments, to facilitate quick synchronization of the operational state information between the previous active processing entity and the new active processing entity, the network device provides a memory that is shared between the two redundant processing entities. In one embodiment, while operating in active mode, the active processing entity is configured to store the operational state information, which it uses for performing the set of functions performed in active mode, to this the shared memory. When a switchover occurs that causes the previous active processing entity to become the new standby processing entity and the previous standby processing entity to become the new active processing entity, the new active processing entity can have immediate access to the operational state information stored in the shared memory by the previous active processing entity, which may now operate in standby mode.

The use of shared memory provides a quick way for the new active processing entity to gain access to operational state information built, maintained, and used by the previous active processing entity. The time and processing overhead and complexity of having to synchronize data from the active to the standby processing entity is reduced. Further, the overall memory required by processing entities for providing high availability can also be reduced since separate memories are not needed for each of the processing entities.

Whenever memory is shared between two or more processing entities, such as between the active and standby processing entities, problems associated with data inconsistency and data corruption need to be closely monitored. Since an event that causes a switchover can occur without any forewarning, for example, in the middle of a memory write operation, there is no way to ensure whether the data stored in the shared memory by the active processing entity is in a consistent state at the point of the switchover. For example, if the switchover occurred as the active processing entity (i.e., the active processing entity prior to the switchover) was writing data to the shared memory, there is no way to ensure whether or not the write operation was successfully completed or whether it was interrupted in the middle, leading possibly to an inconsistent or indeterminate or even corrupted memory state. In such a scenario, when the previous standby processing entity becomes the active entity as a result of the switchover, it may be difficult, if even possible, for the new active processing entity to be able to detect the data inconsistency or corruption in the shared memory and even more difficult for it to recover from this situation without having to rebuild all of the operational state data from scratch—a task that can be very processing—and memory resource-intensive and may adversely affect the availability of the network device.

In certain embodiments, the data inconsistency problems resulting from the use of shared memory, as discussed above, are resolved by using a transactional memory system. In one embodiment, the transactional memory system comprises a memory that can be shared between multiple processing entities, such as between an active processing entity and a standby processing entity. Additionally, the transactional memory system comprises an architecture or framework that guarantees consistency of data stored in the shared memory at the atomicity of a transaction.

For purposes of this disclosure, a transaction is defined as a finite sequence of one or more operations. A transaction may include one or more operations that cause the state of memory to be impacted. These include operations that cause data to be written to the memory (a write operation) and/or an update operation that causes data written to be memory to be updated. An update operation includes a delete operation that deletes data written to memory or an update operation that changes the data written to memory.

In certain embodiments, the transactional memory system ensures the consistency of data stored in the shared memory at a transaction level, where the transaction may comprise one or more operations. The transactional memory system guarantees that changes to the shared memory caused by write and/or update operations are kept consistent at the level or atomicity of a transaction. The transactional memory system treats a transaction as a unit of work; either a transaction completes or does not. The execution of a transaction is considered to be completed if all the sequential operations defined for that transaction are completed. The execution of a transaction is considered not to be completed, i.e., considered to be incomplete, if all the sequential operations defined for that transaction are not completed. In terms of software code, a transaction represents a block of code and the transactional memory system ensures that this block of code is executed atomically. The transactional memory system ensures that changes to memory resulting from execution of the operations in a transaction are committed to the shared memory only upon completion of the transaction. If a transaction starts execution but does not complete, i.e., all the operations in the transaction do not complete, the transactional memory system ensures that any memory changes made by the operations of the incomplete transaction are not committed to the shared memory. Accordingly, the transactional memory system ensures that an incomplete transaction does not have any impact on the data stored in the shared memory. The transactional memory system thus ensures the consistency of the data stored in the shared memory at the boundary or granularity of a transaction.

For example, if the active processing entity receives a switchover-causing event during the execution of a transaction that prevents the active processing entity from completing the transaction (i.e., prevents the active processing entity from completing all the operations in the transaction), the transactional memory system prevents the changes to memory caused by the incomplete transaction from being committed to the shared memory; the shared memory remains in a state as if the partial execution of the transaction did not occur. After the switchover, the new active processing entity can restart the transaction, with a memory state consistent with a state prior to the execution of any of the operations from the transaction by the previously active processing entity. The transactional memory system thus not only enables memory to be shared between an active processing entity and a standby processing entity but also ensures that the new active processing entity, upon a switchover, is guaranteed consistency of the data stored in the shared memory such that the new processing entity can then start performing the set of functions performed in active mode using the data stored in the shared memory. The transactional memory system thus facilitates the synchronization of data between the active processing entity and the standby processing entity in a simple and efficient manner while also ensuring the consistency of the data after a switchover. This helps to reduce the impact on the functions performed by the device upon a switchover and reduces or eliminates the down-time of the device, leading to higher availability.

A transactional memory system may use different techniques to ensure that any memory changes caused by operations of a transaction are committed to the shared memory only upon completion of the transaction, or alternatively, to ensure that any memory changes caused by operations of an incomplete transaction are not committed to the shared memory.

Traditionally, transaction memory has been used for simplifying the concurrent computing problem, where multiple threads executing within the same process are vying for execution of a critical segment of code. These types of problems have been previously addressed using lock-based synchronization methods. However, lock based schemes can be very complex and error prone and require developers to be fully aware of all potential synchronization issues. Transactional memory solves this by abstracting the concurrency issues into atomic transactions. The transactional memory infrastructure may guarantee that transactions are handled properly in a concurrent environment.

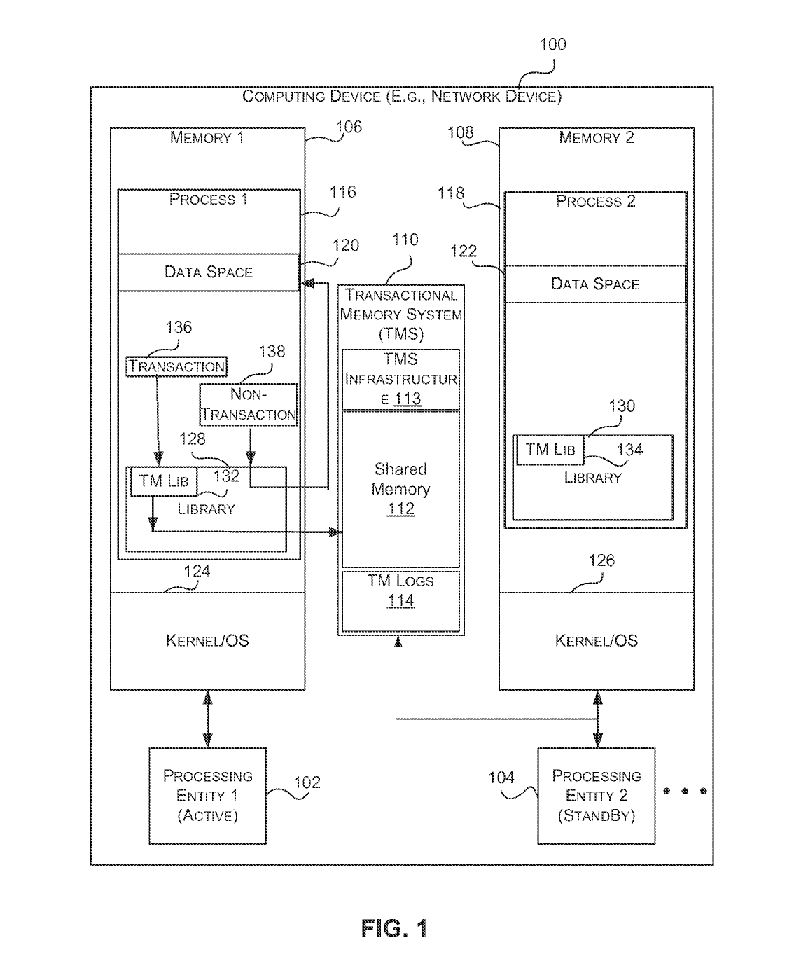

FIG. 1 illustrates a simplified block diagram of a computing device 100 according to one or more embodiments of the invention. An example of a computing device may include a network device. Examples of network devices include devices such as routers or switches that are configured to route or forward data (e.g., packets) in a network. Examples of such network devices include various devices provided by Brocade Communications Systems, Inc. of San Jose, Calif. The computing device 100 depicted in FIG. 1, including its various components, is meant for illustrative purposes only and is not intended to limit the scope of the invention in any manner. Alternative embodiments may have more or fewer components than those shown in FIG. 1.

As shown in FIG. 1, computing device 100 comprises multiple processing entities, including a first processing entity 102 and a second processing entity 104. Although only two processing entities are shown in FIG. 1, other embodiments of computing device 100 may comprise more than two processing entities. A processing entity may be a processor, a group of physical processors, a core of a multicore processor, a group of cores of one or more multicore processor, and combinations thereof.

For example, in one embodiment, a processing entity of computing device 100 (e.g., first processing entity 102 or second processing entity 104) may be a physical processor, such as an Intel, AMD, or TI processor, or an ASIC. In another embodiment, a processing entity may be a group of processors. In another embodiment, a processing entity may be a processor core of a multicore processor. In yet another embodiment, a processing entity may be a group of cores from one or more processors. A processing entity can be any combination of a processor, a group of processors, a core of a processor, or a group of cores of one or more processors.

In certain embodiments, the processing entity may be a virtual processing unit or a software partitioning unit such as a virtual machine, hypervisor, software process or an application running on a processing unit, such as a physical processing unit, core or logical processor. For example, the two or more processing entities may be virtual machines executing or scheduled for execution on one or more physical processing units, one or more cores executing within the same physical processing unit or different physical processing units, or one or more logical processors executing on one or more cores on the same physical processing unit or separate physical processing units.

In certain embodiments, computing device 100 may be configured to operate according to the active/standby model for providing high availability. For example, one or more processing entities may operate in a first mode (e.g., active mode) while one or more other processing entities operate in a second mode (e.g., standby mode). For example, as shown in FIG. 1, at a given point in time, first processing entity 102 may operate in active mode while second processing entity 104 operates in standby (or passive) mode. The processing entity operating in active mode (i.e., the active processing entity) may be configured to perform a certain set of functions that are not performed by a processing entity operating in standby mode (i.e., the standby processing entity). For example, if computing device 100 were a network device such as a router or a switch, the set of functions performed in the active mode may include one or more functions related to forwarding and routing of network data. These functions may not be performed by the standby processing entity.

Upon a switchover, caused by a voluntary or an involuntary event, the standby processing entity is configured to start operating in the active mode and become the new active processing entity and take over performance of the functions performed in active mode. The previous active processing entity may operate in the standby mode and become the new standby processing entity. In this manner, the active-standby model uses redundant processing entities to reduce interruptions in data processing and forwarding and thus provides higher availability for the network device.

In certain implementations, each processing entity may have a dedicated portion of memory assigned to or associated with the processing entity. In one embodiment, the memory assigned to a processing entity is random access memory (RAM). Non-volatile memory may also be assigned in other embodiments. For example, in the embodiment depicted in FIG. 1, first processing entity 102 is coupled to first memory 106 and second processing entity 104 is coupled to second memory 108.

Software instructions (e.g., software code or program) that are executed by a processing entity may be loaded into the memory coupled to that processing entity. This software may be, for example, loaded into the memory upon initiation or boot-up of the processing entity. In one embodiment, as depicted in FIG. 1, the loaded software may include an operating environment (OS) and/or kernel (i.e., 124 and 126), along with various drivers, computer applications, and other software modules. In one embodiment, if computing device 100 is a network device, a network operating system (NOS) may be also loaded into the memory after the operating system has been loaded.

As depicted in FIG. 1, memory 106 is associated with first processing entity 102 and memory 108 is associated with second processing entity 104. One or more applications may be loaded into memories 106 and 108 and executed by processing entities 102 and 104 respectively. An application may comprise one or more processes that are executed by the processing entities. In some embodiments, a process may be an instantiation of an application or computer program. For example, as shown in FIG. 1, a first process 116 may be loaded into a portion of memory 106 and executed by first processing entity 102. A second process 118 may be loaded into a portion of memory 108 and executed by second processing entity 104. Each process may have its own memory space (data space) for storing and manipulating data during execution of the process, for example, data space 120 for first process 116 and data space 122 for second process 108. In certain implementations, a process may have multiple threads/streams of operations for executing operations concurrently.

As previously described, computing device 100 may be configured to operate according to the active/standby model. For example, first processing entity 102 may operate in active mode while second processing entity 104 operates in standby (or passive) mode. When the first processing entity 102 operates in active mode, one or more applications or processes may be loaded into memory 106 associated with first processing entity 102 and executed by first processing entity 102. These applications and processes, when executed by first processing entity 102, may perform a certain set of functions that are performed in the active mode (and not performed in the standby mode).

In certain embodiments, when first processing entity 102 is operating in the active mode, second processing entity 104 may operate in the standby mode. When the second processing entity 104 operates in standby mode, one or more applications or processes may be loaded into memory 108 associated with second processing entity 104 and executed by second processing entity 104. These applications and processes, when executed by first processing entity 104, may perform a set of functions that are performed in the standby mode.

In certain embodiments, a transactional memory system (TMS) 110 is provided to facilitate communication of data between first processing entity 102 and second processing entity 104 (or, in general, between any two processing entities of computing device 100). As depicted in FIG. 1, transactional memory system 110 comprises a shared memory 112 and an infrastructure 113 that guarantees consistency of data stored in shared memory 112 at the atomicity of a transaction.

In certain embodiments, shared memory 112 can be shared between multiple processing entities of computing device 100. For purposes of this disclosure, sharing a memory between two processing entities, such as between a first processing entity and a second processing entity, implies that the memory can be shared between at least one process or application executed by the first processing entity and at least one process or application executed by the second processing entity. For example, in FIG. 1, shared memory 112 may be shared between first processing entity 102 and second processing entity 104 such that shared memory 112 is shared between process 116 executed by first processing entity 102 and process 118 executed by second processing entity 104. Both processes 116 and 118 can read from and write data to shared memory 112.

First memory 106, second memory 108, and shared memory 112 may be physically configured in a variety of ways without departing from the scope of the invention. For example, first memory 106, second memory 108, and shared memory 110 may reside one or more memory banks connected to the processing entities using shared or dedicated busses in computing device 100.

As shown in FIG. 1, transactional memory system 110 also comprises an infrastructure 113 that guarantees consistency of data stored in shared memory 112 at the atomicity of a transaction. In conjunction with shared memory 112, infrastructure 113 guarantees that changes to shared memory 112 caused by write and/or update operations are kept consistent at the level or atomicity of a transaction. Transactional memory system 110 ensures that changes to memory 112 resulting from execution of the operations in a transaction are committed to shared memory 112 only upon completion of the transaction. If a transaction starts execution but does not complete, i.e., all the operations in the transaction do not complete, transactional memory system 110 ensures that any memory changes made by the operations of the incomplete transaction are not committed to shared memory 112. Accordingly, transactional memory system 110 ensures that an incomplete transaction does not have any impact on the data stored in shared memory 112. Transactional memory system 110 thus ensures the consistency of the data stored in shared memory 112 at the boundary or granularity of a transaction. For example, in one embodiment, if a transaction executed by a processing entity encounters an event during the execution of the transaction that causes execution of the transaction to stop execution without completing all of the operations for the transaction, transactional memory system 110 may cause any memory changes resulting from the execution of the operations of the incomplete transaction to be rolled as if those operations were never executed. Since shared memory 112 is part of transactional memory system 110, it is also referred to as transaction memory 112.

Transactional memory system 110 may be implemented using several software or hardware components, or combinations thereof. In one embodiment, infrastructure 113 may be implemented in software, for example, using the software transactional memory support provided by GNU C Compiler (GCC) (e.g., libitm runtime library provided by GCC 4.7). Infrastructure 113 may also be implemented in hardware using transactional memory features provided by a processor. Transactional memory system 110 may also be provided using a hybrid (combination of software and hardware) approach.

In certain embodiments, a process executed by a processing entity may make use of transactional memory system 110 by linking to and loading a runtime library (132 and 134) (e.g., the libitm library provided by GCC (128 and 130)) that provides various application programming interfaces (APIs) that make use of transactional memory system 110. Operations that belong to a transaction may make use of the APIs provided by such a library such that any memory operations performed by these operations use transactional memory system 110 instead of non-transactional memory. Operations that do not want to use transactional memory system 100 may use APIs provided by non-transactional libraries such that any memory operations performed using these non-transactional memory APIs use data space 120 instead of transactional memory system 110. For example, as shown in FIG. 1, a transactional operation 136 may use APIs provided by a transactional memory library (TM lib) 132 that causes transactional memory system 110 to be used for any memory operations; and a non-transactional operation 138 may use non-transactional memory libraries/APIs. For example, in one implementation, operations in a transaction that use transactional memory system 110 may be routed through TM lib 132, which provides the interface to interact with the transactional memory system 110. TM lib 132 may provide APIs for allocation of shared memory 112, reading and writing to shared memory 112, and the like. In this manner, all memory related operations in a transaction are routed via TM lib 132 to transactional memory system 110.

In certain implementations, transactional memory system 110 uses TM logs 114 to guarantee consistency of data stored in shared memory 112 on a per transaction basis. In one embodiment, for a sequence of operations in a transaction, information tracking changes to shared memory 112, due to execution of the operations of the transaction, is stored in TM logs 114. The information stored is such that it enables transactional memory system 110 to reverse the memory changes if the transaction cannot be completed. In this manner, the information stored in TM logs 114 is used by transactional memory system 110 to reverse or unwind any memory changes made due to execution of operations of an incomplete transaction.

For example, for a transaction that comprises an operation that writes data to a memory location in shared memory 112, information may be stored in a TM log 114 related to the operation and the memory change caused by the operation. For example, the information logged to a TM log 114 by transactional memory system 110 may include information identifying the particular operation, the data written by the operation or the changes to the data at the memory location resulting from the particular operation, the memory location in shared memory 112 where the data was written, and the like. If for some reason the transaction could not be completed, transactional memory system 110 then uses the information stored in TM log 114 for the transaction to reverse the changes made by the write operation and restore the state of transactional memory 112 to a state prior to the execution of any operation in the transaction as if the transaction was never executed. For an incomplete transaction, the TM log information is thus used to rewind or unwind the shared memory changes made by any executed operations of an incomplete transaction. The memory changes made by operations of an incomplete transaction are not committed to memory 112. The memory changes are finalized or committed to memory only after the transaction is completed. TM logs 114 themselves may be stored in shared memory 112 or in some other memory in or accessible to transactional memory system 110.

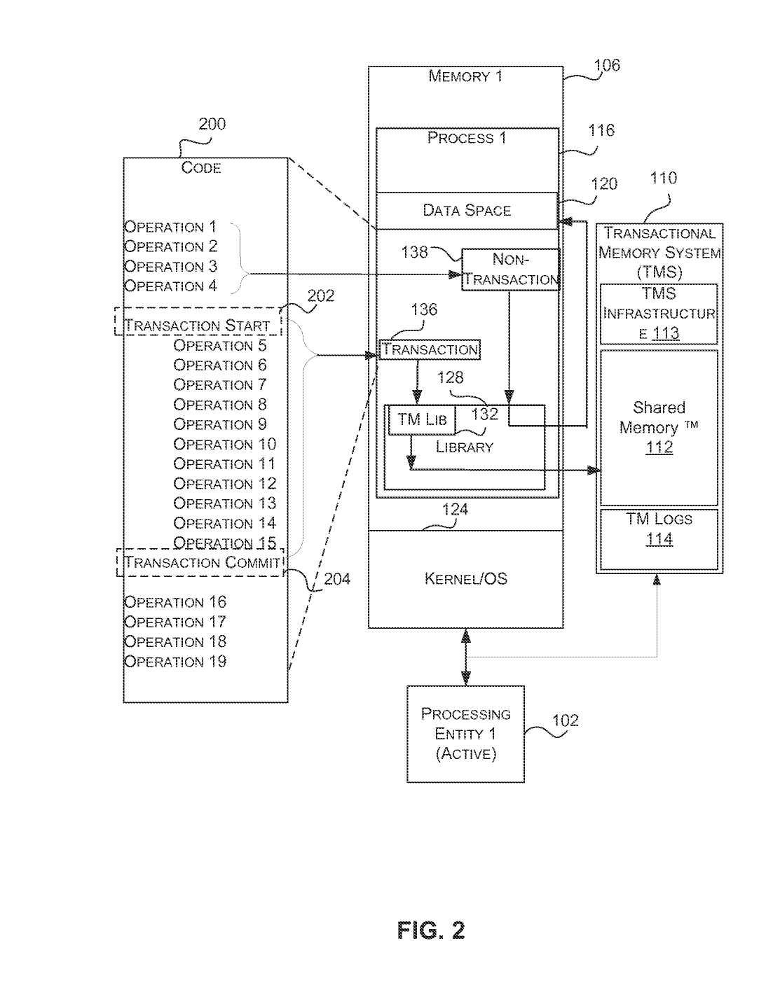

FIG. 2 illustrates a simplified computer program designed to operate with a transactional memory system executing according to one or more embodiments. As depicted in FIG. 2, first process 116 loaded into first memory 106 and executed by first processing entity 102 may contain code 200 comprising a plurality of sequential operations (e.g., code instructions). One or more blocks of code (e.g., a set of sequential operations) of code 200 may be tagged as transactions. In the example depicted in FIG. 2, the set of operations from operation _{—}5 to operation _{—}15 are tagged as belonging to single transaction 136 whereas the other operations are not tagged as belonging to any transaction. The transaction is demarcated using “transaction start” (202) and “transaction commit” (204) delimiters. In one embodiment, the “transaction start” and “transaction commit” delimiters indicate to transactional memory system 110 that the operations 5-15 are considered part of the same transaction 136, whereas the operations outside the “transaction start” and “transaction commit” demarcations are considered non-transactional operations 138.

The operations that make up a transaction are generally preconfigured. In one embodiment, a system programmer may indicate what operations or portions of code constitute a transaction. A piece of code may comprise one or more different transactions. The number of operations in one transaction may be different from the number of operations in another transaction. For example, a programmer may define a set of sequential operations related that impact memory as a transaction.

When code 200 is executed due to execution of process 116 by first processing entity 102, operations that are part of a transaction, such as operations 5-15, use the transactional memory APIs provided by TM lib 132 and as a result shared or transactional memory 112 is used for the memory operations. Operations that are not part of a transaction, such as operations 1-4 and 16-19, use a non-transactional memory library and, as a result, any memory operations resulting from these operations are made to data space 120 within the memory portion allocated for process 116 in memory 106.

For a transaction, the block of code corresponding to operations in the transaction is treated as an atomic unit. In one embodiment, the “transaction start” indicator (or some other indicator) indicates the start of a transaction to first processing entity 102 and the “transaction commit” indicator (or some other indicator) indicates the end of the transaction. The operations in a transaction are executed in a sequential manner by first processing entity 102. As each transaction operation is executed, if the operation results in changes to be made to shared memory 112 (e.g., a write or update operation to shared memory 112), then, in one embodiment, the information is logged to a TM log 114. In this manner, as each operation in a transaction is executed, any memory changes caused by the execution operation is logged to TM log 114. If all the operations in the transaction (i.e., operations 5-15 for the transaction shown in FIG. 2) are successfully completed, then the changes made to shared memory 112 are made permanent or committed to shared memory 112. However, if the transaction could not successfully complete, then any shared memory 112 changes made by executed operations of the incomplete transaction are reversed using information stored in TM logs 114. In this manner, the changes made by an incomplete transaction are not committed to shared memory 112.

Similarly, in one implementation, the TM log 114 may also be protected in a similar manner as other memory operations using the transactional memory system, wherein the transaction is committed to memory only after the writes to the TM log 114 are completed to memory. In the event that the transaction is interrupted with a switchover event before the writes to the TM log 114 are completed, the transaction may be considered incomplete and the TM log 114 may be discarded.

For example, while executing code 200, first processing entity 102 may receive an event that causes code execution by first processing entity 102 to be interrupted. If the interruption occurs when the transaction comprising operations 5-15 is being executed, then any shared memory 112 changes made by the already executed operations of the incomplete transaction are reversed, using information stored in TM logs 114. For example, if the interruption occurs when operation _{—}9 has been executed and operation _{—}10 is about to be executed, any changes to shared memory 112 caused by execution of operations 5-9 are reversed and not committed to shared memory 112. In this manner, transactional memory system 110 ensures that the state of data stored in shared memory 112 is as if the incomplete transaction was never executed.

As described above, the processing entities in computing device 100 may be configured to operate according to the active/standby model wherein one processing entity operates in active mode performing a set of functions that are performed in active mode, and concurrently, another processing entity operates in standby mode and does not perform the set of functions performed in active mode. For example, in the embodiment depicted in FIGS. 1 and 2, first processing entity 102 is shown as operating in active mode and second processing entity 104 operates in standby mode. When a switchover occurs due to the occurrence of a voluntary or involuntary switchover-causing event, second processing entity 104, which, prior to the event, was operating in standby mode, starts to operate in active mode and becomes the new active processing entity. As a result of the switchover, first processing entity 102, which was operating in active mode prior to the switchover, may, as a result of the switchover, start operating in standby mode and become a standby processing entity.

In certain embodiments, transactional memory system 110 enables operational state information built, maintained, and used by the active processing entity prior to a switchover to be made accessible to the new processing entity after the switchover. Further, by organizing the operations performed in the active mode into transactions, transactional memory system 110 ensures that the data stored in shared memory 112 is in a consistent state at the atomicity of a transaction. The new active processing entity is thus assured about the consistency of the operational state information stored in shared memory 112 and can immediately start using the information to perform the active mode set of functions without any downtime. Transactional memory system 110 thus provides not only a way for the operational state information to be seamlessly made available to the new active processing entity upon a switchover but also ensures consistency of the information at a per transaction level.

In certain embodiments, the transactional memory 112 and the TM log 114 may be implemented using memory that is persistent across a switchover from the first processing entity 102 to the second processing entity 104. In certain example scenarios, the switchover may result in a partial or complete reboot of the system. During the reboot, the power planes associated with the processing entities and the memory may also be rebooted. Rebooting of the power planes may result in losing of the data stored in memory. In certain embodiments, to avoid losing data stored in the shared memory 112 and the TM logs 114, the library may allocate the memory using persistent memory. In one implementation, persistent memory may be implemented using non-volatile memory, such as flash, that retains data even when not powered. In another implementation, persistent memory may be implemented by keeping the memory powered during the period when the computing device 100 reboots. In some implementations, the shared memory 112 and the TM logs 114 may be implemented on a separate power plane so that they do not lose power and consequently data while other entities in the network device, lose power and reboot.

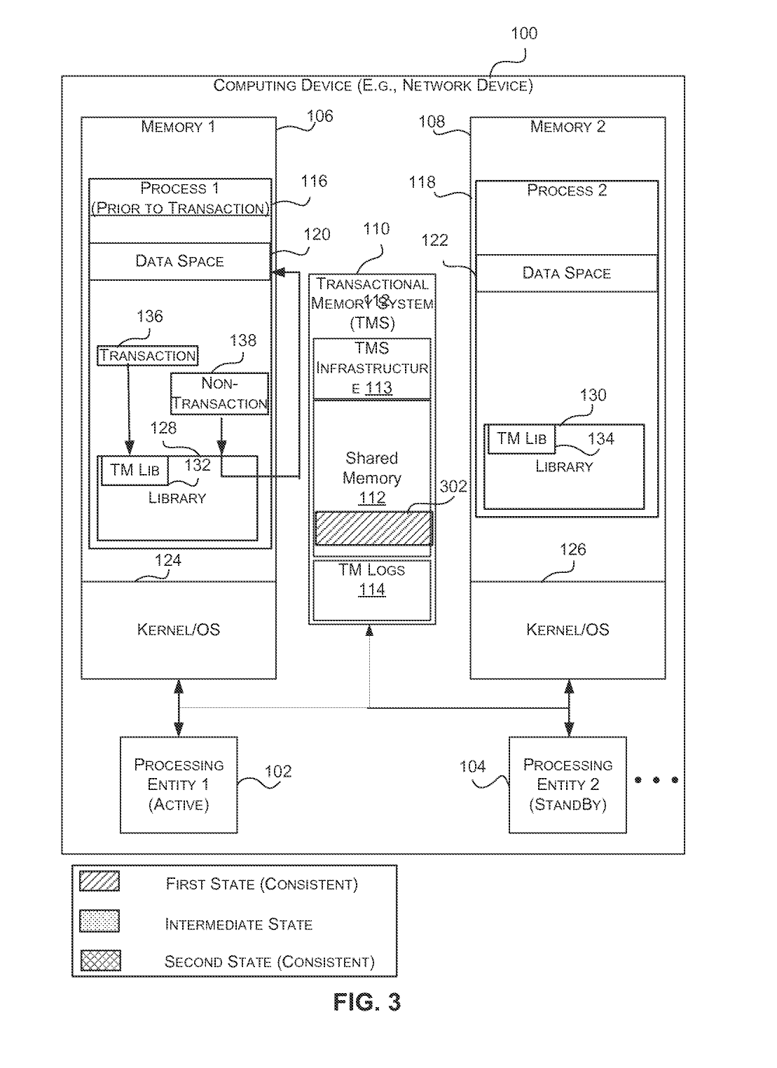

FIGS. 3-7 depict a step-by-step example describing the effects of a switchover on first and second processing entities and the use of transactional memory system 110 according to an embodiment of the present invention.

FIG. 3 illustrates a simplified block diagram of the computing device, prior to execution of a transaction, according to one or more embodiments of the invention. At the step depicted in FIG. 3, the first processing entity 102 is operating in an active mode and the second processing entity 104 is operating in a standby mode (or passive mode). The first processing entity 102 may be performing operations that are not part of a transaction. For example, referring back to FIG. 2, the first processing entity 102 may be executing an operation, such as operation _{—}4 in this step. In some implementations, the memory for the transaction may be allocated before the start of the transaction. In other implementations, the memory for the transaction may be allocated by operations executing as part of the transaction. In the step depicted by FIG. 3, block 302 of the shared memory 112 illustrates the block of memory in a first state, prior to execution of the transaction.

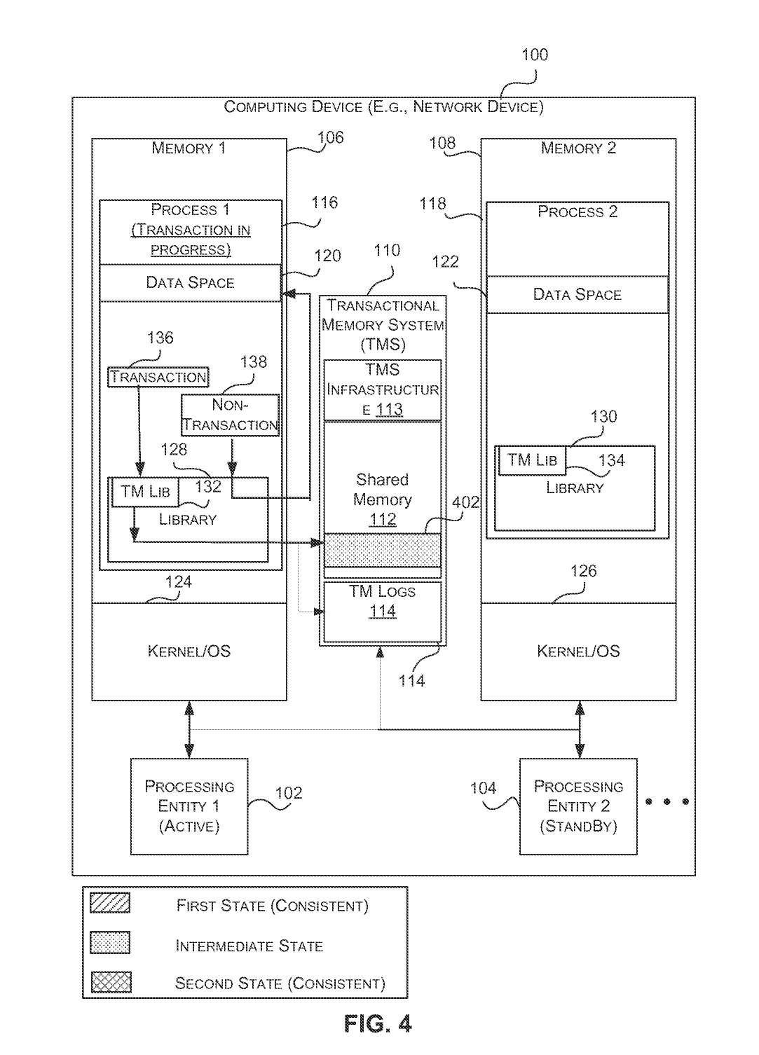

FIG. 4 illustrates a simplified block diagram of the computing device, depicting the shared memory state during the execution of the transaction, according to one or more embodiments of the invention. In the step depicted in FIG. 4, the first processing entity 102 commences execution of the transaction. Commencing execution of the transaction may refer to starting execution of an operation belonging to a transaction, such as operation _{—}5 from FIG. 2. During the execution of the transaction 136, one or more operations from the transaction 136, executing on the first processing entity 102 may modify the contents of memory, as shown as block 402 in FIG. 4. In FIG. 4, block 402 depicts the memory in an indeterminate and possible inconsistent state. For example, at any given point in time, during the execution of the transaction, it may be possible for a memory transaction to be in flight and in an incomplete state, resulting in the indeterminate state of the memory during the execution of the transaction.

In one embodiment, in addition to changing a portion of the shared memory 112 for each memory operation from the transaction, the TM logs 114 may also be updated to reflect the changes to shared memory 112. In certain implementations, transactional memory system uses TM logs 114 to guarantee consistency of data stored in shared memory 112 on a per transaction basis. In one embodiment, for a sequence of operations in a transaction, information tracking changes to shared memory 112, due to execution of the operations of the transaction, are stored in TM logs 114. The information stored is such that it enables transactional memory system 110 to reverse the memory changes if the transaction cannot be completed. In this manner, the information stored in TM logs 114 is used by transactional memory system 110 to reverse or unwind any memory changes made due to execution of operations of an incomplete transaction.

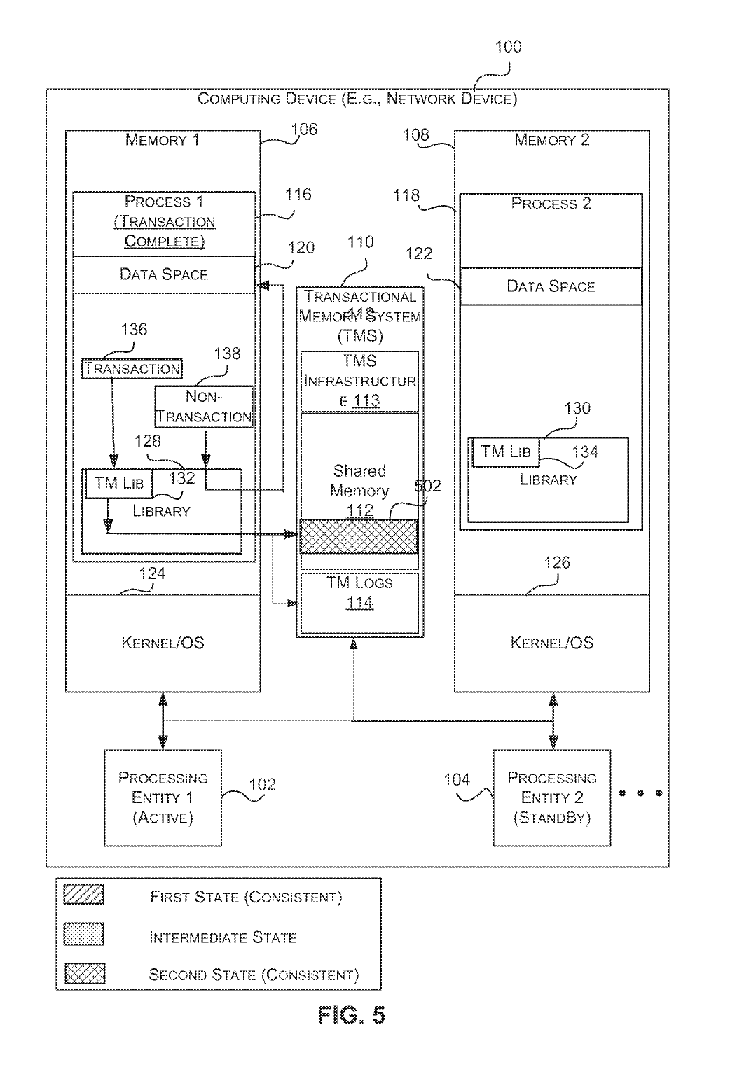

FIG. 5 illustrates a simplified block diagram of the computing device, depicting the shared memory state after the transaction is completed and committed, according to one or more embodiments of the invention. Once the transaction is committed, the transactional memory system guarantees that changes to the shared memory caused by write and/or update operations are consistent. The execution of a transaction is considered to be completed if all the sequential operations defined for that transaction are completed. The execution of a transaction is considered not to be completed, i.e., considered to be incomplete, if all the sequential operations defined for that transaction are not completed. The transactional memory system ensures that changes to memory resulting from execution of the operations in a transaction are committed to the shared memory only upon completion of the transaction.

Committing changes to memory may include an update of the internal state (of the processing hardware and/or library) reflecting that all the operations associated with the transaction have been completed. In addition, in some implementations, committing of the transaction may also update the TM logs 114. In one implementation, the information associated with a completed transaction may be deleted from the TM logs. However, in other implementations, the changes associated with the completed transaction may be buffered for a few transactions for later use for recovering transactions. Once the transaction is completed and committed, the shared memory 112 is in a second consistent state 502. The completion of the transaction and committing of the changes to the shared memory place the allocated memory for the transaction (i.e., memory block 502) in a determinate state. Any switchover occurring between the first processing entity 102 and second processing entity 104 after the completion of the transaction may continue execution of the computer program on the second processing entity 104 from the subsequent operation and/or transaction.

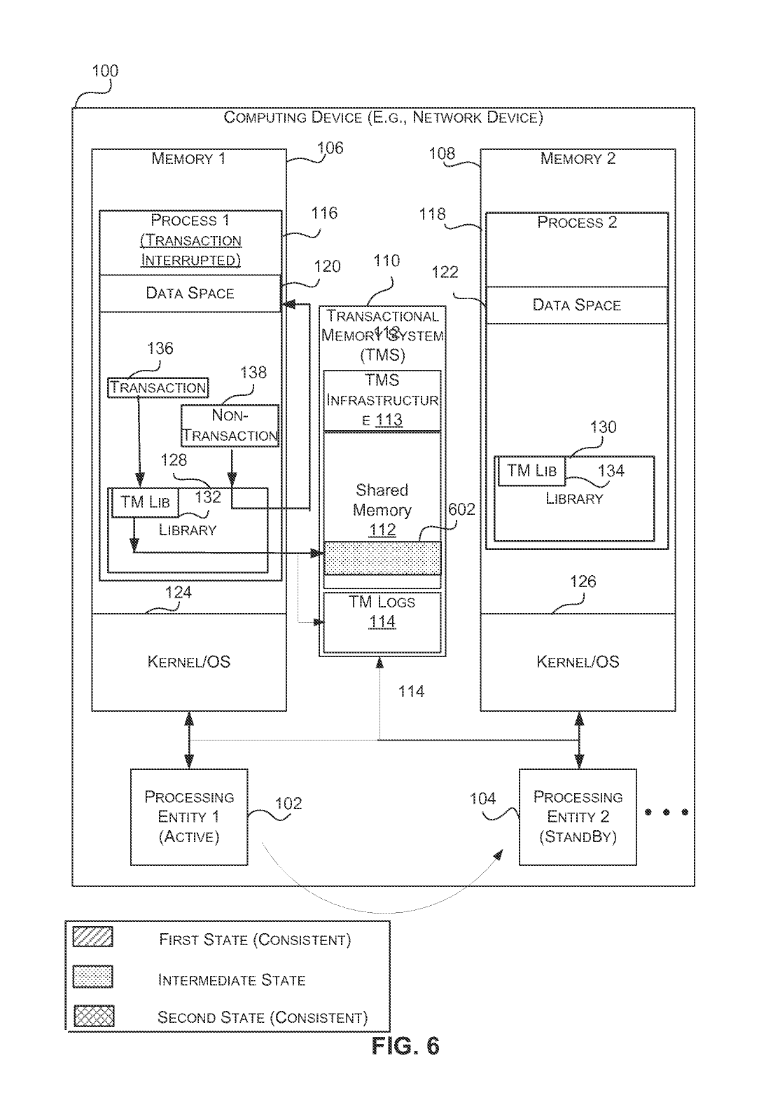

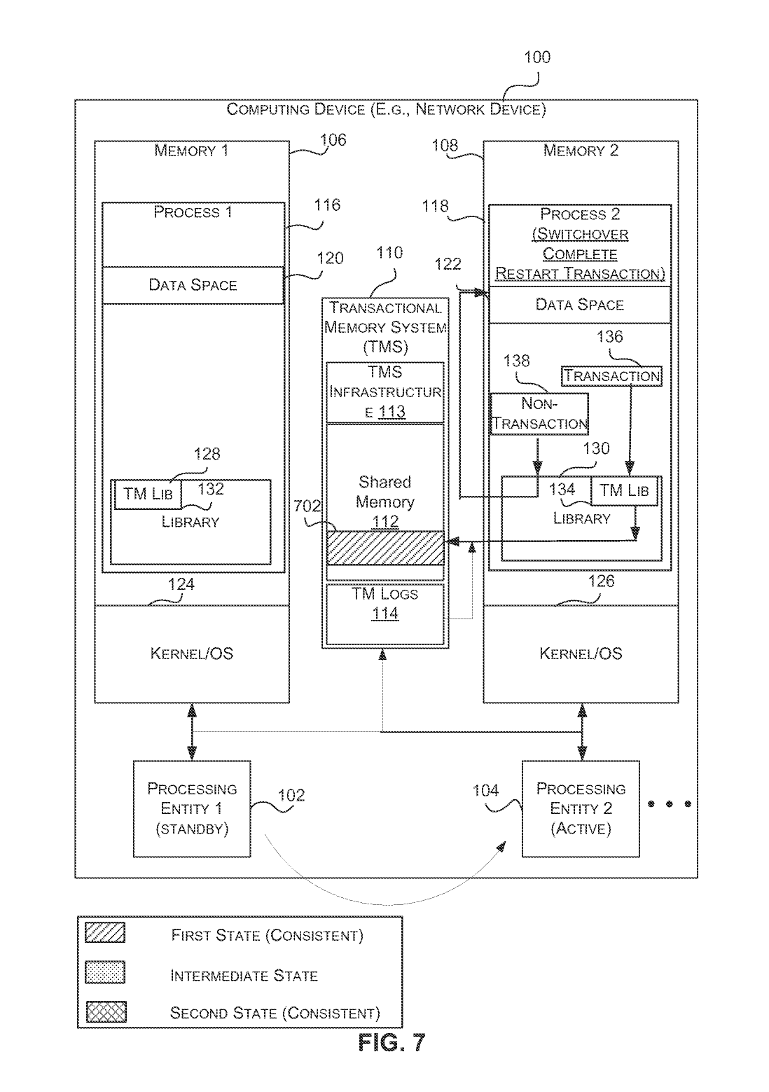

FIG. 6 illustrates a simplified block diagram of the computing device, depicting a scenario that includes interrupting a transaction executing on the first processing entity after commencing of a transaction, but before completion of the transaction, according to one or more embodiments of the invention. FIG. 6 depicts a scenario that follows from the execution of the transaction from FIG. 4, but does not complete the transaction as depicted in FIG. 5. The interruption of the transaction could be due to a voluntary event (e.g., system upgrade) or an involuntary switchover event (e.g., failure event). The interruption in the execution of the transaction may result in the first processing entity 102 failing to complete the rest of the operations from the transaction. In such a scenario, where an asynchronous event interrupts the execution of the operations of the transaction, some of the memory operations targeted towards a portion of the shared memory 602 may have completed, while others may still be in flight. Due to such an asynchronous event, the state of the portion of the shared memory (block 602) being manipulated by the operations of the transaction is in an indeterminate state. Traditionally, such indeterminacy of the shared memory state during a catastrophic event would be prohibitive in sharing memory between an active and standby processing entity, since the second processing entity 104 could not depend on the contents of the portion of shared memory (block 602) after the switchover. However, as previously discussed and also depicted below with reference to FIG. 7, the transactional memory system 110 enables recovery from such an interruption allowing sharing of memory between an active and standby processing entity for the purposes of facilitating a switchover.

FIG. 7 illustrates a simplified block diagram of the computing device depicting the switchover of the second processing entity from the standby mode to the active mode. In the scenario depicted in FIG. 6, where the first processing entity 102 is interrupted from completing the transaction, the second processing entity 104 may take over as the active processing entity instead of the first processing entity 102. FIG. 7 shows the switchover between the first processing entity and the second processing entity, wherein, after the switchover, the second processing entity executes as the active processing entity. In one implementation, after the switchover, the transactional memory system 110 restores the state of the transactional memory for the transaction from an indeterminate state back to the first state 702, as if the transaction had never executed. In one implementation, the transactional memory system 110 uses information stored in the TM logs 114 regarding the executed operations of the transaction for rewinding the changes to the portion of the shared memory 702 and returning it the first state. Once the portion of the shared memory 702 between the first processing entity and the second processing entity is reverted back to the state before the execution of the transaction (i.e., first state), the second processing entity 104 can re-execute the same transaction as if the transaction was being executed for the first time.

The transactional memory system 110, as shown in FIG. 6 and FIG. 7, operates to allow the computing device 100 to switch the processing entity acting as the active processing entity instantaneously, upon a switchover event, using the shared memory 112, that is guaranteed to be consistent using the transactional memory system 110. In certain embodiments, where the computing device 100 is a network device, the transactional memory system 110 can safeguard the consistency of the critical routing data, during the switchover of the second processing entity 104 from a standby processing entity to an active processing entity.

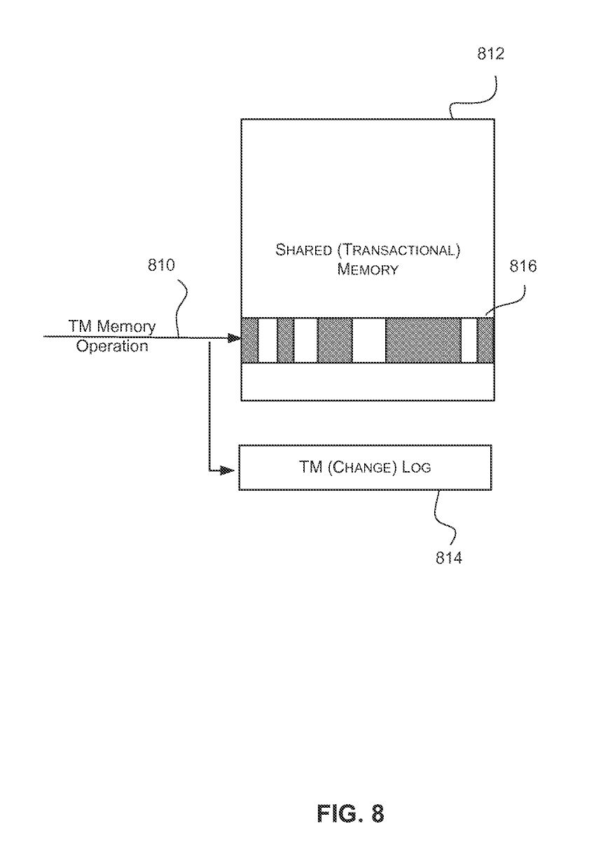

FIG. 8 illustrates a simplified block diagram for writing to shared memory allocated as part of the transactional memory system according to certain embodiments of the invention. FIG. 8 represents an implementation of transactional memory system similar to what has been described with reference to FIGS. 1-7. In FIG. 8, execution of TM memory operations 810 may result in changes to the shared memory 812, maintained as part of the transactional memory system and may be stored to the shared memory 812 itself. Along with storing the change to shared memory 812, the changes or representation of the changes are also stored in the TM logs 814. The TM logs 814 may also be referred to as change logs. In certain embodiments, the transactional memory system uses TM logs 814 to guarantee consistency of data stored in shared memory 816 on a per transaction basis. In one embodiment, for a sequence of operations in a transaction, information tracking changes to a portion of the shared memory 816 due to execution of the operations of the transaction is stored in the TM log 814. The information stored is such that it enables the transactional memory system to reverse the memory changes if the transaction cannot be completed. In this manner, the information stored in TM logs 814 is used by the transactional memory system to reverse or unwind any memory changes made due to execution of operations of an incomplete transaction.

For example, for a transaction that comprises an operation that writes data to a memory location in shared memory 816, information may be stored in a TM log 114 related to the operation and the memory change caused by the operation. For example, the information logged to a TM log 814 by transactional memory system may include information identifying the particular operation, the data written by the operation or the changes to the data at the memory location resulting from the particular operation, the memory location in shared memory where the data was written, and the like. If for some reason the transaction could not be completed, transactional memory system 110 then uses the information stored in TM log 114 for the transaction to reverse the changes made by the write operation and restore the state of portion of the shared memory 816 to a state prior to the execution of any operation in the transaction as if the transaction was never executed. For an incomplete transaction, the TM log information is thus used to rewind or unwind the shared memory changes made by any executed operations of an incomplete transaction. The memory changes made by operations of an incomplete transaction are not committed to memory 812. The memory changes are finalized or committed to memory only after the transaction is completed. TM logs 814 themselves may be stored in shared memory 812 or in some other memory in or accessible to transactional memory system.

As described earlier, the changes to the portion of the shared memory 816 are committed to shared memory 812 at the transaction boundary. For example, in FIG. 2, the changes are committed upon execution of the “transaction commit” 204. In one implementation, committing the changes to transactional memory at the transaction boundary may refer to updating the entries in the TM log 814 so that the changes from the completed transaction are no longer preserved in the TM log 814 and may be overwritten by subsequent writes. In one implementation, after completion of the transaction, the TM log 814 may no longer support rolling back of the changes made to the shared memory by operations from the transaction. In FIG. 8, as described in FIG. 6 and FIG. 7, if the transaction stops without completing the transaction, the changes to the shared memory 112 may be rolled back, using information stored in the TM logs 814.

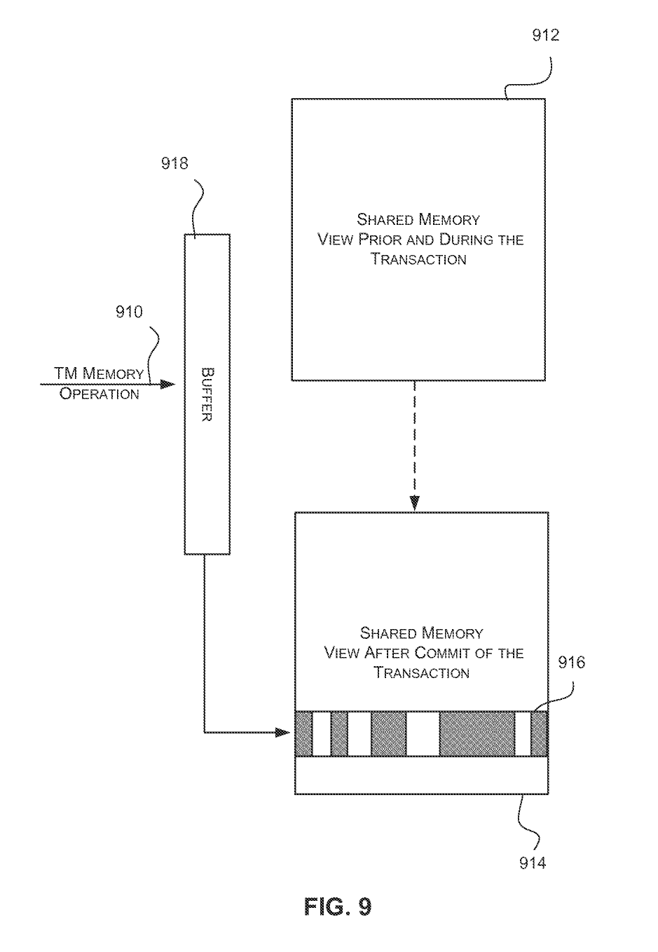

FIG. 9 illustrates a simplified block diagram for writing to shared memory allocated as part of the transactional memory system, according to another embodiment of the invention. As depicted in FIG. 9, in the transaction memory system, the intended changes for memory locations 916 by the TM memory operations 910 during the execution of a transaction are buffered in one or more buffers 918. The changes targeted for shared memory 912 are not written to the shared memory 912 until the completion of the transaction (as shown in block 914). Shared Memory 912 depicts the view of memory before and during the execution of the transaction, whereas shared memory 914 depicts the view of the memory once the transaction is completed and committed. At completion of the transaction, the changes buffered in the buffer 918 are committed to the shared memory. In some implementations, committing the changes to shared memory may refer to pushing out the changes from the buffer 918 to the shared memory once the transaction completes.

In one implementation, the buffer 918 shown in FIG. 9 may be implemented using a write-back cache in a processor. For example, writeback caches in a processor operate by writing back the contents of any particular location of the cache to memory at the time the data at the location in the cache is evicted (e.g., pushed out of the cache to be stored in memory—usually due to storing of another value at the same cache location). Reading and writing directly from cache instead of memory result in much faster execution of operations.

In one implementation of a cache-based transactional memory system, all memory write operations during the execution of the transaction to the memory region reserved as the shared memory 912 region may be written to the processor cache instead of the shared memory 912. The memory write operations during the execution of the transaction to the memory region reserved as the shared memory 912 region may also be tagged as transactional memory stores in the cache. In one implementation, during the execution of the transaction, the stores tagged as transactional memory stores in the processor are preserved in the caches and protected from evictions (i.e., being pushed out to the memory) until the completion of the transaction.

At the completion of the execution of the transaction, all the stores targeted to the shared memory 912 are committed to the memory 916. In the above example implementation, committing of the memory operations to transactional memory 916 may refer to evicting all the transaction memory writes stored in the caches to the shared memory 914.

In FIG. 9, shared memory 912 shows a view of the memory before or during the execution of the transaction, whereas shared memory 914 shows a view of the same memory space after the completion of the transaction. In memory 914, the completion and committing of the transaction results in memory stores are buffered in the temporary buffer 918 before being flushed out to the shared memory (as shown as block 916).

Although FIGS. 1-7 are depicted using an implementation of a transactional memory system similar to the one described with reference to FIG. 8, other implementations similar to the implementation described with reference to FIG. 9 or any other combinations or variations may also be used without departing from the scope of the invention. For example, in FIGS. 1 and 4, instead of storing to the shared memory 112 and TM logs 114 during the execution of the transaction, the stores targeted for the shared memory may be buffered in system hardware, such as the processor cache or other buffers implemented on the system. Furthermore, in FIG. 5, upon completion of the transaction, as part of committing the memory operations, all cache locations tagged as transaction memory data may be pushed out from the caches and written to memory at the time of the completion of the transaction.

On the other hand, in a scenario similar to FIG. 6, if the computing device 100 encounters a switchover event during the execution of the transaction, all cache locations tagged as transactional memory in the caches may be discarded from the caches. Therefore, in the event of a switchover, the intermediate data stored in the cache may never be written to memory, therefore retaining the first state of the portion of the transaction memory. In such an implementation, in FIG. 7, the second processing entity 104, after switching to the active entity, may have to do minimal processing before commencing the interrupted transaction from the first processing entity 102, since the portion of shared memory is already in a consistent state (i.e., the first state).

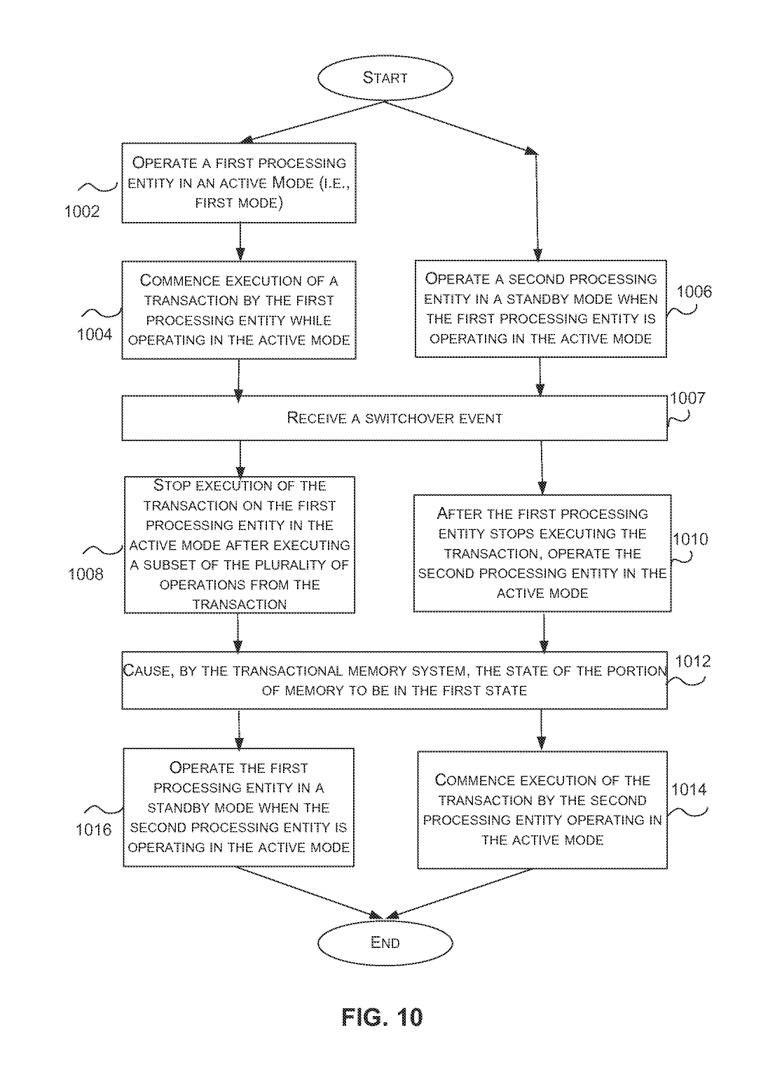

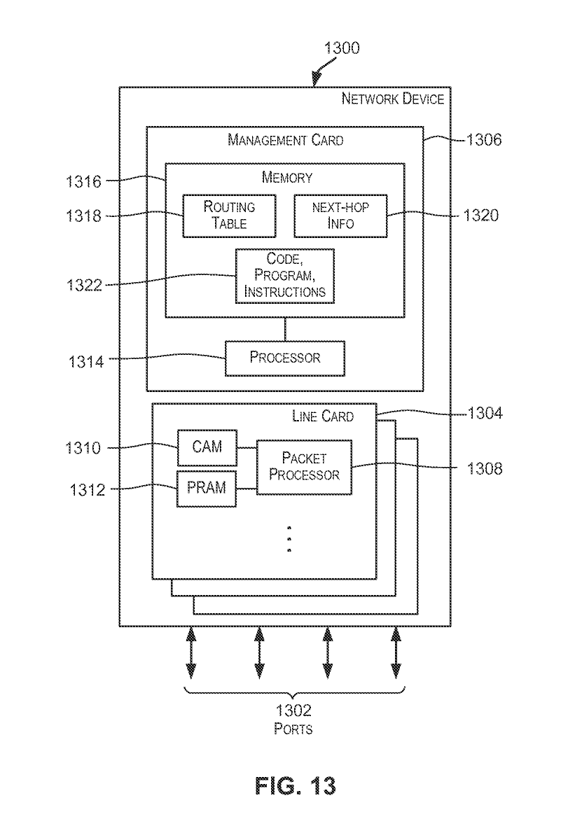

FIG. 10 depicts a simplified flowchart 1000 illustrating the method performed according to one or more embodiments of the invention. According to one or more aspects, any and/or all of the methods and/or method steps described herein may be implemented by components of the network device 1300 described in FIG. 13. In other implementations, the method may be performed by components of the network device described in FIG. 1-9. In one embodiment, one or more of the method steps described below with respect to FIG. 10 are implemented by one or more processing entities of the network device. Additionally or alternatively, any and/or all of the methods and/or method steps described herein may be implemented in computer-readable instructions, such as computer-readable instructions stored on a computer-readable medium such as the memory, storage or another computer readable medium.

At step 1002, the first processing entity of the network device may operate in an active mode. The first processing entity may be configured to perform a first set of tasks in the active mode. The first set of tasks may include routing network messages from one endpoint to another endpoint in a network. An example of the first mode is an active mode.

At step 1004, the first processing entity commences execution of a transaction while operating in the first mode. The transaction may include a plurality of operations. Some of the operations may be memory operations and operable to perform write transactions on a portion of memory. The portion of the memory may be in a first state prior to commencing execution of the transaction by the first processing entity.

At step 1006, the second processing entity of the network device operates in a second mode when the first processing entity is operating in the first mode. The second processing entity may be configurable to not perform the first set of tasks in the second mode. An example of a second mode may be a standby mode.

At step 1007, the network device may receive an event. In one embodiment, the event is an asynchronous event. The event may be a voluntary event, such as a request for software upgrade for the software executing on the first processing entity or an involuntary event such as an error associated with the first processing entity or the network device itself.

At step 1008, the first processing entity, operating in the first mode, stops execution of the transaction on the first processing entity in the first mode in response to the event (from block 1007) after executing a subset of the plurality of operations from the transaction. In some embodiments, at least one from the plurality of operations may not be included in the subset of the plurality of operations. The subset may be operable to change the state of the portion of the memory from the first state to a different state when the transaction is committed to the portion of the memory. In other words, the subset has fewer operations than all the operations in the transaction.

At step 1010, after the first processing entity stops executing the transaction in the first mode, the second processing entity may operate in the first mode instead of the first processing entity. In one implementation, the first processing entity may operate in the second mode after stopping execution of the transaction on the first processing entity in the first mode. In one implementation, the portion of the memory does not change from the time when the first processing entity stops executing the transaction in the first mode and the second processing entity starts operating in the first mode. In one implementation, the portion of the memory does not change state by maintaining power to the portion of the memory. In another implementation, the portion of the memory does not change state, since the portion of the memory is implemented using non-volatile memory.

At step 1012, a transactional memory system may cause the state of the portion of the memory to be in the first state. In one implementation, as depicted in FIG. 8, causing the state of the portion of memory to be in the first state, prior to commencement of the execution of the transaction by the second processing entity, may include tracking changes to the portion of the memory by the first processing entity during the execution of the transaction on the first processing entity, and reverting the changes back to the first state prior to commencement of the execution of the transaction by the second processing entity. For example, the second processing entity may use information from the TM logs stored in memory during the execution of the transaction on the first processing entity to roll back the changes to the portion of memory and cause the state of the portion of the memory to be in the first state.

In another implementation, as depicted in FIG. 9, causing the state of the portion of memory to be in the first state, prior to commencement of the execution of the transaction by the second processing entity, may include buffering changes directed to the portion of the memory during executing of the transaction in a memory buffer, and discarding the buffered changes in the memory buffer.

At step 1014, the second processing entity commences execution of the transaction in the first mode. In one implementation, the first processing entity, at step 1016, may start operating in the second mode (such as standby mode) while the second processing entity is operating in the active mode.

It should be appreciated that the specific steps illustrated in FIG. 10 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination therebetween. Moreover, the individual steps illustrated in FIG. 10 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process.

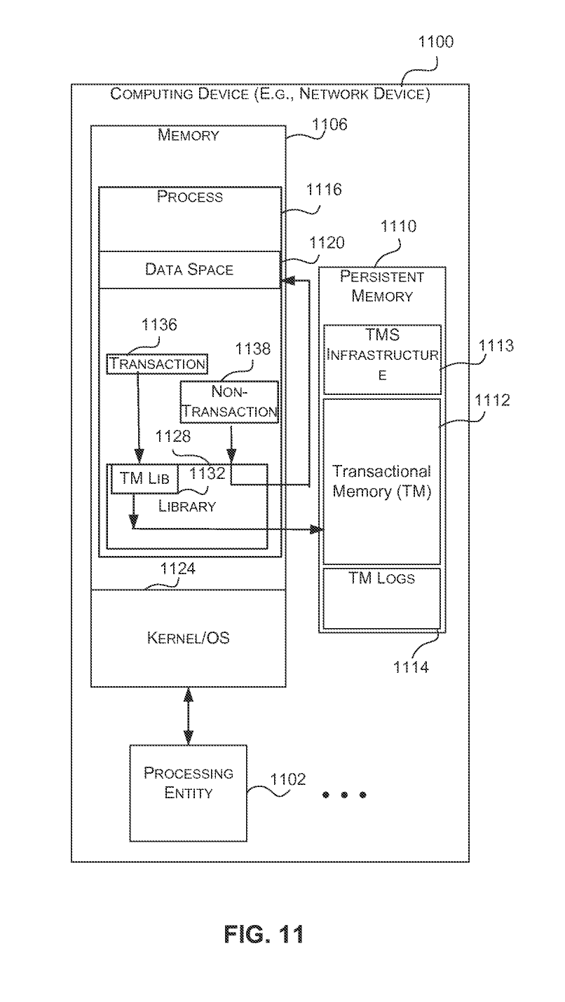

FIG. 11 illustrates another simplified block diagram of a computing device according to one or more embodiments of the invention. An example of a computing device may include a network device. Examples of network devices include devices such as routers or switches that are configured to route or forward data (e.g., packets) in a network. Examples of such network devices include various devices provided by Brocade Communications Systems, Inc. of San Jose, Calif. The computing device 1100, depicted in FIG. 11, including its various components, is meant for illustrative purposes only and is not intended to limit the scope of the invention in any manner. Alternative embodiments may have more or fewer components than those shown in FIG. 11.

As shown in FIG. 11, computing device 1100 may include one or more processing entities. Although, only one processing entity is shown in FIG. 11, other embodiments of computing device 1100 may comprise more than one processing entity. A processing entity may be a processor, a group of physical processors, a core of a multicore processor, a group of cores of one or more multicore processors, and combinations thereof.

For example, in one embodiment, a processing entity of computing device 1100 may be a physical processor, such as an Intel, AMD, TI processor or an ASIC. In another embodiment, a processing entity may be a group of processors. In another embodiment, a processing entity may be a processor core of a multicore processor. In yet another embodiment, a processing entity may be a group of cores from one or more processors. A processing entity can be any combination of a processor, a group of processors, a core of a processor, or a group of cores of one or more processors.

In certain embodiments, the processing entity may be a virtual processing unit or a software partitioning entity such as a virtual machine, hypervisor, software process or an application running on a processing unit, such as a physical processing unit, core or logical processor. For example, the two or more processing entities may be virtual machines executing or scheduled for execution on one or more physical processing units, one or more cores executing within the same physical processing unit or different physical processing units, or one or more logical processors executing on one or more cores on the same physical processing unit or separate physical processing units.

In certain implementations, each processing entity may have a dedicated portion of memory assigned to or associated with the processing entity. In one embodiment, the memory assigned to a processing entity is random access memory (RAM). Non-volatile memory may also be assigned in other embodiments. For example, in the embodiment depicted in FIG. 11, the processing entity 1102 is coupled to memory 1106.

Software instructions (e.g., software code or program) that are executed by a processing entity may be loaded into the memory coupled to that processing entity. This software may be, for example, loaded into the memory upon initiation or boot-up of the processing entity. In one embodiment, as depicted in FIG. 11, the loaded software may include an operating environment (OS) and/or kernel (i.e., 1124), along with various drivers, computer applications, and other software modules. In one embodiment, if computing device 1100 is a network device, a network operating system (NOS) may be also loaded into the memory after the operating system has been loaded.

As depicted in FIG. 11, memory 1106 is associated with processing entity 1102. One or more applications may be loaded into memory 1106 and executed by processing entity 102. An application may comprise one or more processes that are executed by the processing entities. In some embodiments, a process may be an instantiation of an application or computer program. For example, as shown in FIG. 11, a process 1116 may be loaded into a portion of memory 1106 and executed by first processing entity 1102. Each process may have its own memory space (data space) for storing and manipulating data during execution of the process, for example, data space 1120 for the process 1116. In certain implementations, a process may have multiple threads/streams of operations for executing operations concurrently.

In certain computing devices, such as network devices supporting high availability may be desirable for networking equipment vendors. In some embodiments, high availability is facilitated by providing robust recovery from errors. As discussed herein, the technique described improve robust recovery of a process 1116 executing on a processing entity 1102.

State recovery of a process has a similar problem to a switchover, wherein, if the process encounters an unrecoverable error during updating of memory, the memory may be left in an inconsistent state. In such a scenario, the process may not be able to recover without going through a full stateless process restart if the memory is in an inconsistent state. On the other hand, if the error condition or corruption is undetected and an attempt is made to restart the process at the point of the error, it is very likely the process may misbehave resulting in data loss or a process crash.

In certain embodiments, the state of the process 1116 executing on the processing entity 1102 may be preserved and restarted upon encountering an unrecoverable error condition resulting in a process 1116 crash during the execution of instructions associated with the process 1116. In one implementation, the changes to memory may be rolled back or reverted to a prior consistent/determinate state and the instructions are re-executed on the processing entity 1102. Using transactional memory techniques with persistent memory (e.g., non-volatile memory) allows the process to recover to a state prior to the execution of the transaction, wherein the transaction comprises a plurality of operations. The changes made during the execution of the operations from the transaction may be reverted back if the transaction is interrupted before the transaction is committed to memory.

As depicted in FIG. 11, transactional memory system 1110 comprises a transactional memory 1112 and an infrastructure 1113 that guarantee consistency of data stored in shared memory 1112 at the atomicity of a transaction. As shown in FIG. 11, transactional memory system 1110 also comprises an infrastructure 1113 that guarantees consistency of data stored in transactional memory 1112 at the atomicity of a transaction. In conjunction with transactional memory 1112, infrastructure 1113 guarantees that changes to transactional memory 1112 caused by write and/or update operations are kept consistent at the level or atomicity of a transaction. Transactional memory system 1110 ensures that changes to memory 1112 resulting from execution of the operations in a transaction are committed to transactional memory 1112 only upon completion of the transaction. If a transaction starts execution but does not complete, i.e., all the operations in the transaction do not complete, transactional memory system 1110 ensures that any memory changes made by the operations of the incomplete transaction are not committed to transactional memory 1112. Accordingly, transactional memory system 1110 ensures that an incomplete transaction does not have any impact on the data stored in transactional memory 1112. Transactional memory system 1110 thus ensures the consistency of the data stored in transactional memory 1112 at the boundary or granularity of a transaction. For example, in one embodiment, if a transaction executed by a processing entity encounters an event during the execution of the transaction that causes execution of the transaction to stop execution without completing all of the operations for the transaction, transactional memory system 1110 may cause any memory changes resulting from the execution of the operations of the incomplete transaction to be rolled as if those operations were never executed.

Transactional memory system 1110 may be implemented using several software, hardware components, or combinations thereof. In one embodiment, infrastructure 1113 may be implemented in software, for example, using the software transactional memory support (block 1132) provided by GNU C Compiler (GCC) (e.g., libitm runtime library provided by GCC 4.7). Infrastructure 1113 may also be implemented in hardware using transactional memory features provided by a processor. Transactional memory system 1110 may also be provided using a hybrid (combination of software and hardware) approach.

In certain embodiments, a process executed by a processing entity may make use of transactional memory system 1110 by linking to and loading a runtime library 1132 (e.g., the libitm library provided by GCC (1128)) that provides various application programming interfaces (APIs) that make use of transactional memory system 1110. Operations that belong to a transaction may make use of the APIs provided by such a library such that any memory operations performed by these operations use transactional memory system 1110 instead of non-transactional memory. Operations that do not want to use transactional memory system 1100 may use APIs provided by non-transactional libraries such that any memory operations performed using these non-transactional memory APIs use data space 1120 instead of transactional memory system 1110. For example, as shown in FIG. 11, a transactional operation 1136 may use APIs provided by a transactional memory library (TM lib) 1132 that causes transactional memory system 1110 to be used for any memory operations; and a non-transactional operation 1138 may use non-transactional memory libraries/APIs. For example, in one implementation, operations in a transaction that use transactional memory system 1110 may be routed through TM lib 1132, which provides the interface to interact with the transactional memory system 1110. TM lib 1132 may provide APIs for allocation of transactional memory 1112, reading and writing to transactional memory 1112, and the like. In this manner, all memory-related operations in a transaction are routed via TM lib 1132 to transactional memory system 1110.

In certain implementations, the transactional memory system uses TM logs 1114 to guarantee consistency of data stored in transactional memory 1112 on a per transaction basis. In one embodiment, for a sequence of operations in a transaction, information tracking changes to transactional memory 1112 due to execution of the operations of the transaction is stored in TM logs 1114. The information stored is such that it enables transactional memory system 1110 to reverse the memory changes if the transaction cannot be completed. In this manner, the information stored in TM logs 1114 is used by transactional memory system 1110 to reverse or unwind any memory changes made due to execution of operations of an incomplete transaction.

For example, for a transaction that comprises an operation that writes data to a memory location in transactional memory 1112, information may be stored in a TM log 1114 related to the operation and the memory change caused by the operation. For example, the information logged to a TM log 1114 by transactional memory system 1100 may include information identifying the particular operation, the data written by the operation or the changes to the data at the memory location resulting from the particular operation, the memory location in transactional memory 1112 where the data was written, and the like. If, for some reason, the transaction could not be completed, transactional memory system 1110 then uses the information stored in TM log 1114 for the transaction to reverse the changes made by the write operation and restore the state of transactional memory 1112 to a state prior to the execution of any operation in the transaction as if the transaction was never executed. For an incomplete transaction, the TM log 1114 information is thus used to rewind or unwind the shared memory changes made by any executed operations of an incomplete transaction. The memory changes made by operations of an incomplete transaction are not committed to memory 1112. The memory changes are finalized or committed to memory only after the transaction is completed. TM logs 1114 themselves may be stored in transactional memory 1112 or in some other memory in or accessible to transactional memory system 1110.

In addition to the memory 1106, according to certain embodiments of the invention, the computing device 1100 may have one or more portions of memory that may be persistent across the failure or reboot of the processing entity 1102. In one embodiment, the persistent memory 1110 may be implemented using non-volatile memory. In another embodiment, the persistent memory 1110 may be implemented by maintaining power to the one or more portions of memory while the process 1116 and/or processing entity 1102 recovers or reboots. In one implementation, the persistent memory 1110 may be part of the memory 1106. For example, if the memory 1106 for the processing entity and the memory 1110 were both implemented using non-volatile memory, in one embodiment there may be no need for implementing memories (1106 and 1110) separately.

In certain implementations, such as shown in FIG. 8, changes to the transactional memory 1112 caused by the execution of one or more operations from the transaction may be tracked in the TM logs 1114. The TM logs 1114 may also be stored in persistent memory 1110. For example, when a write operation from the transaction modifies a memory location in the transactional memory 1112, the associated changes may also be logged in the TM log 1114. In the event, the transaction stops without completing the transaction, the state of the transactional memory 1112 may be restored to the state prior to the execution of the transaction using information from the TM logs 1114. However, in other implementations, the transactional memory system may be implemented using an approach similar to the approach discussed in FIG. 9, where the changes to the transaction are buffered in buffers (e.g., caches) and committed to memory when the transaction completes.

In certain implementations, using transactional memory 1112 with TM logs 1114 may allow for a robust recovery from an unrecoverable error in the processing of the process 1116. The processing entity 1102 can restart from the same transaction, even in the event that the processing entity stops after partially completing the transaction that included several memory manipulations, leaving the memory in an indeterminate and/or inconsistent state. Even if the memory is in an indeterminate state, the processing entity 1102 after rebooting can use the TM logs 1114 stored in the persistent memory 1110 and restore the state of the transactional memory 1112 to a state prior to the execution of the transaction at the processing entity 1102. In certain embodiments, the processing entity 1102 may commence the transaction after restoring the transactional memory 1112.

In certain embodiments, the transactional memory 1112 and the TM log 1114 may be implemented in persistent memory 1110 that is persistent across a reboot of the processing entity. During the reboot processes, the power planes associated with the processing entities and the memory may also be rebooted. Rebooting of the power planes may result in losing of the data stored on the memory. In certain embodiments of the invention, to avoid losing the data stored in the transactional memory 1112 and the TM logs 1114 memory may be allocated in persistent memory 1110. In one implementation, persistent memory may be implemented using non-volatile memory, such as flash, that retains data even when not powered. In another implementation, persistent memory may be implemented by keeping the memory powered even when the computing device 1100 reboots. In some implementations, the persistent memory 1110 may be implemented on a separate power plane so that the persistent memory 1110 does not lose power and data while other entities in the network device, lose power and reboot.

Accordingly, as described above, embodiments of the invention may enable the computing device 1100 to recover back to the transaction in a consistent manner without having to rebuild the entire state. This may reduce down-time for the computing device 1100 in high availability network devices.

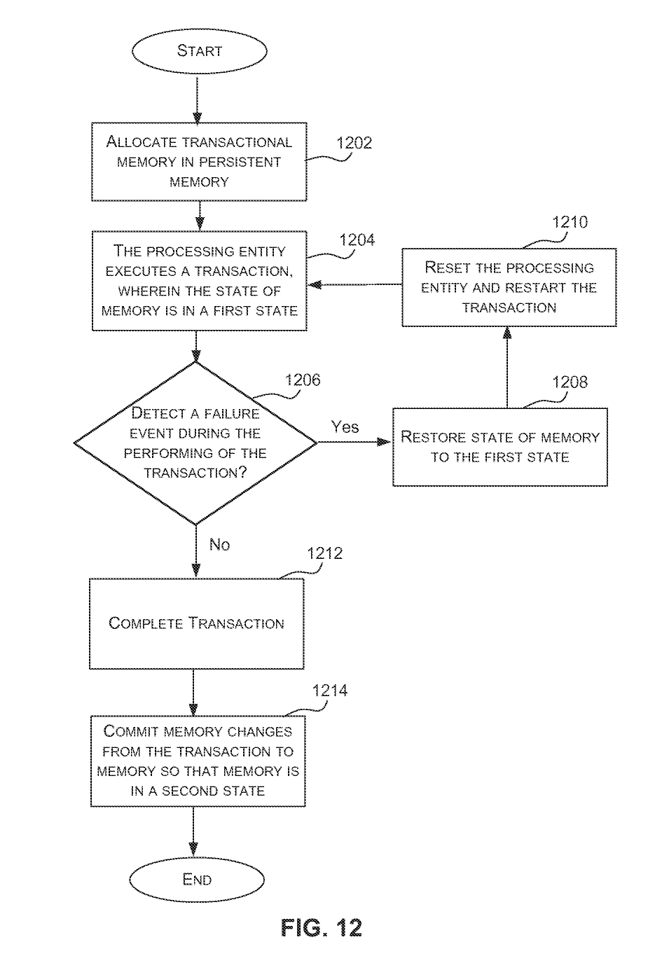

FIG. 12 depicts a simplified flowchart 1200 illustrating the method performed according to one or more embodiments of the invention. According to one or more aspects, any and/or all of the methods and/or method steps described herein may be implemented by components of the network device 1300 described in FIG. 13. In other implementations, the method may be performed by components of the network device described in FIG. 11. In one embodiment, one or more of the method steps described below with respect to FIG. 12 are implemented by one or more processing entities of the network device. Additionally or alternatively, any and/or all of the methods and/or method steps described herein may be implemented in computer-readable instructions, such as computer-readable instructions stored on a computer-readable medium such as the memory, storage or another computer readable medium.

At step 1202, embodiments of the invention may allocation transaction memory 1112 in persistent memory 1110, as shown in FIG. 11. In one example, the allocation step may occur before the start of the transaction within a process, wherein the process explicitly makes a TM library call to allocate transactional memory 1112. Additional parameters may be provided to indicate that the transactional memory is to be allocated in persistent memory 1110. In another example, the allocation of the transactional memory may be implicit based on the context of the allocation call performed by the process. For example, if the allocation of memory is requested from within a transaction, in one implementation, the allocation of memory may be inherently interpreted as a transactional memory allocation request.

At step 1204, the processing entity 1112 may commence execution of the transaction on the processing entity 1102. In one implementation, the state of the transaction memory allocated is in a first state prior to the execution of the transaction.

At step 1206, if no failure is detected and the transaction completes (step 1212), then the processing entity 1102 commits changes to the transactional memory 1112, so that the memory is in a second state (step 1214).

On the other hand, if an error is detected or a signal is received to restart the process executing on the processing entity 1112, before the completion of the transaction (i.e., all the operations in the transaction), the processing entity 1112 may restore the state of the transactional memory 1112 to the first state upon restarting the process. At step 1210, the processing entity 1112 may reset the state of the process and the processing entity and restart the transaction at 1204.

It should be appreciated that the specific steps illustrated in FIG. 12 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination therebetween. Moreover, the individual steps illustrated in FIG. 12 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process.

FIG. 13 depicts a simplified block diagram of a network device 1300 that may be configured to perform embodiments of the present invention. The network device 1300 illustrates only one management card and linecard for illustrating purposes, but may be extended to provide multiple management cards and linecards. Network device 1300 may be a router or switch that is configured to forward data such as a router or switch provided by Brocade Communications Systems, Inc. In the embodiment depicted in FIG. 13, network device 1300 comprises a plurality of ports 1302 for receiving and forwarding data packets and multiple cards that are configured to perform processing to facilitate forwarding of the data packets. The multiple cards may include one or more linecards 1304 and one or more management cards 1306. A card, sometimes also referred to as a blade or module, can be inserted into the chassis of network device 1300. This modular design allows for flexible configurations with different combinations of cards in the various slots of the device according to differing network topologies and switching requirements. The components of network device 1300 depicted in FIG. 13 are meant for illustrative purposes only and are not intended to limit the scope of the invention in any manner. Alternative embodiments may have more or fewer components than those shown in FIG. 13.

Ports 1302 represent the I/O plane for network device 1300. Network device 1300 is configured to receive and forward data using ports 1302. A port within ports 1302 may be classified as an input port or an output port depending upon whether network device 1300 receives or transmits a data packet using the port. A port over which a data packet is received by network device 1300 is referred to as an input port. A port used for communicating or forwarding a data packet from network device 1300 is referred to as an output port. A particular port may function both as an input port and an output port. A port may be connected by a link or interface to a neighboring network device or network. Ports 1302 may be capable of receiving and/or transmitting different types of data traffic at different speeds including 1 Gigabit/sec, 10 Gigabits/sec, or more. In some embodiments, multiple ports of network device 1300 may be logically grouped into one or more trunks.

Upon receiving a data packet via an input port, network device 1300 is configured to determine an output port for the packet for transmitting the data packet from the network device to another neighboring network device or network. Within network device 1300, the packet is forwarded from the input network device to the determined output port and transmitted from network device 1300 using the output port. In one embodiment, forwarding of packets from an input port to an output port is performed by one or more linecards 1304. Linecards 1304 represent the data forwarding plane of network device 1300. Each linecard 1304 may comprise one or more packet processing entities 1308 that are programmed to perform forwarding of data packets from an input port to an output port. A packet processing entity on a linecard may also be referred to as a line processing entity. Each packet processing entity 1308 may have associated memories to facilitate the packet forwarding process. In one embodiment, as depicted in FIG. 13, each packet processing entity 1308 may have an associated content addressable memory (CAM) 1310 and a RAM 1312 for storing forwarding parameters (RAM 1312 may accordingly also be referred to as a parameter RAM or PRAM). In one embodiment, for a packet received via an input port, the packet is provided to a packet processing entity 1308 of a linecard 1304 coupled to the input port. The packet processing entity receiving the packet is configured to determine an output port of network device 1300 to which the packet is to be forwarded based upon information extracted from the packet. The extracted information may include, for example, the header of the received packet. In one embodiment, a packet processing entity 1308[??] is configured to perform a lookup in its associated CAM 1310, using the extracted information. A matching CAM entry then provides a pointer to a location in the associated PRAM 1312 that stores information identifying how the packet is to be forwarded within network device 1300. Packet processing entity 1308 then facilitates forwarding of the packet from the input port to the determined output port.

Since processing performed by a packet processing entity 1308 needs to be performed at a high packet rate in a deterministic manner, packet processing entity 1308 is generally a dedicated hardware device configured to perform the processing. In one embodiment, packet processing entity 1308 is a programmable logic device such as a field programmable gate array (FPGA). Packet processing entity 1308 may also be an ASIC.

Management card 1306 is configured to perform management and control functions for network device 1300 and thus represents the management plane for network device 1300. In one embodiment, management card 1306 is communicatively coupled to linecards 1304 and includes software and hardware for controlling various operations performed by the linecards. In one embodiment, a single management card 1306 may be used for all the linecards 1304 in network device 1300. In alternative embodiments, more than one management card may be used, with each management card controlling one or more linecards.

A management card 1306 may comprise a processing entity 1314 (also referred to as a management processing entity) that is configured to perform functions performed by management card 1306 and associated memory 1316. As depicted in FIG. 13, the routing table 1318 and associated next-hop and RI information may be stored in memory 1316. The next-hop and RI information may be stored and used in an optimized manner as described above. Memory 1316 is also configured to store various programs/code/instructions 1322 and data constructs that are used for processing performed by processing entity 1314 of management card 1306. For example, programs/code/instructions, which when executed by processing entity 1314 cause the next-hop information to be stored in an optimized manner may be stored in memory 1316. In one embodiment, processing entity 1314 is a general purpose microprocessor such as a PowerPC, Intel, AMD, or ARM microprocessor, operating under the control of software 1322 stored in associated memory 1316. In yet other embodiments, virtual machines running on microprocessors may act as one or more execution environments running on the network device.

In one embodiment, the functions performed by management card processing entity 1314 include maintaining a routing table, creating associations between routes in the routing table and next-hop information, updating the routing table and associated next-hop information responsive to changes in the network environment, and other functions. In one embodiment, management processing entity 1314 is configured to program the packet processing entities and associated memories of linecards 1304 based upon the routing table and associated next-hop information. Programming the packet processing entities and their associated memories enables the packet processing entities to perform data packet forwarding in hardware. As part of programming a linecard packet processing entity and its associated memories, management processing entity 1314 is configured to download routes and associated next-hops information to the linecard and program the packet processing entity and associated memories. Updates to the next-hop information are also downloaded to the linecards to enable the packet processing entities on the linecards to forward packets using the updated information.

What is claimed is:

1. A network device comprising:
a first processing entity;
a second processing entity; and
a transactional memory system comprising a memory shareable between the first processing entity and the second processing entity;
wherein the first processing entity is configurable to:
operate in a first mode, wherein a first set of tasks are performed in the first mode;
commence, while operating in the first mode, execution of a transaction comprising a plurality of operations, wherein a portion of the memory is in a first state prior to commencing execution of the transaction by the first processing entity; and
wherein the second processing entity is configurable to operate in a second mode when the first processing entity is operating in the first mode, the first set of tasks not performed by the second processing entity when operating in the second mode;
wherein, in response to an event:
the first processing entity is configurable to stop execution of the transaction after execution of a subset of operations from the plurality of operations, wherein at least one operation from the plurality of operations is not included in the subset of operations executed by the first processing entity, the subset operable to change the state of the portion of the memory from the first state to a different state when committed to the portion of the memory;
the transactional memory system is configurable to cause the state of the portion of memory to be in the first state;
the second processing entity is configurable to:
operate in the first mode instead of the second mode;
while operating in the second mode, access information stored in the memory, and using the accessed information, commence performance of the first set of functions including commencing execution of the transaction.

2. The network device of claim 1, wherein the portion of the memory does not change from the time when the first processing entity stops executing the transaction in the first mode and the second processing entity starts operating in the first mode.

3. The network device of claim 1, wherein the portion of the memory does not change from the time when the first processing entity stops executing the transaction in the first mode and the second processing entity starts operating in the first mode by maintaining power to the portion of the memory.

4. The network device of claim 1, wherein the first processing entity stops executing the transaction in the first mode in response to detecting a failure condition during the execution of the transaction.

5. The network device of claim 1, wherein the first processing entity stops executing the transaction in the first mode in response to a signal.

6. The network device of claim 1, further comprises operating the first processing entity in the second mode after stopping execution of the transaction on the first processing entity in the first mode.

7. The network device of claim 1, wherein causing the state of the portion of memory to be in the first state prior to commencement of the execution of the transaction by the second processing entity comprises:
tracking changes to the portion of the memory by the first processing entity during the executing of the transaction on the first processing entity; and
reverting the changes back to the first state prior to commencement of the execution of the transaction by the second processing entity.

8. The network device of claim 1, wherein causing the state of the portion of memory to be in the first state prior to commencement of the execution of the transaction by the second processing entity comprises:
buffering changes directed to the portion of the memory during executing of the transaction in a memory buffer; and
discarding the buffered changes in the memory buffer.

9. The network device of claim 1, wherein the first processing entity executes the transaction from within a first process while operating in the first mode.

10. The network device of claim 1, wherein the first processing entity executes a first process operating within a first virtual machine and the second processing entity executes a second process operating within a second virtual machine.

11. A method comprising:
operating a first processing entity of a network device in a first mode, wherein a first set of tasks are performed in the first mode;
commencing, while operating the first processing entity in the first mode, execution of a transaction comprising a plurality of operations, wherein a portion of the memory is in a first state prior to commencing execution of the transaction by the first processing entity;
stopping execution of the transaction after execution of a subset of operations from the plurality of operations in response to an invent, wherein at least one operation from the plurality of operations is not included in the subset of operations executed by the first processing entity, the subset operable to change the state of the portion of the memory from the first state to a different state when committed to the portion of the memory;
operating a second processing entity of the network device in a second mode when the first processing entity is operating in the first mode, the first set of tasks not performed by the second processing entity when operating in the second mode;
wherein after the first processing entity stops executing the transaction in the first mode:
causing, by a transactional memory system, the state of the portion of memory to be in the first state;
operating the second processing entity in the first mode; and
commencing, by the second processing entity, execution of the transaction.

12. The method of claim 11, wherein the portion of the memory does not change from the time when the first processing entity stops executing the transaction in the first mode and the second processing entity starts operating in the first mode.

13. The method of claim 11, wherein the portion of the memory does not change from the time when the first processing entity stops executing the transaction in the first mode and the second processing entity starts operating in the first mode by maintaining power to the portion of the memory.

14. The method of claim 11, wherein the event is a failure condition during the executing of the transaction.

15. The method of claim 11, wherein the event is a signal.

16. The method of claim 11, further comprises operating the first processing entity in the second mode after stopping execution of the transaction on the first processing entity in the first mode.

17. The method of claim 11, wherein causing the state of the portion of memory to be in the first state prior to commencement of the execution of the transaction by the second processing entity comprises:
tracking changes to the portion of the memory by the first processing entity during the execution of the transaction on the first processing entity; and
reverting the changes back to the first state prior to commencement of the execution of the transaction by the second processing entity.

18. The method of claim 11, wherein causing the state of the portion of memory to be in the first state prior to commencement of the execution of the transaction by the second processing entity comprises:
buffering changes directed to the portion of the memory during executing of the transaction in a memory buffer; and
discarding the buffered changes in the memory buffer.

19. The method of claim 11, wherein the first processing entity executes the transaction from within a first process while operating in the first mode.

20. The method of claim 11, wherein the first processing entity executes a first process operating within a first virtual machine and the second processing entity executes a second process operating within a second virtual machine.
